(19) United States
(12) Patent Application Publication
(10) Pub. No.: US 2026/0061348 A1
(43) Pub. Date: Mar. 5, 2026

(54) INTEGRATED POOL FILTRATION SYSTEM

(71) Applicant: John Chen, Alpharetta, GA (US)

(72) Inventor: John Chen, Alpharetta, GA (US)

(21) Appl. No.: 18/820,749

(22) Filed: Aug. 30, 2024

(51) Int. Cl. B01D 29/60; B01D 29/50; B01D 35/26; B01D 35/30

(52) U.S. Cl. CPC B01D 29/60; B01D 29/50; B01D 35/26; B01D 35/30

(57) ABSTRACT

An integrated pool filtration system according to various aspects of the present technology is configured to provide a single fully contained unit incorporating a full suite of equipment for pool filtration to provide a simpler installation option. In one embodiment, the system comprises an inlet and an outlet that can be easily connected to the plumbing system of a pool and an electrical panel that can be connected to an appropriate power source eliminating the need for a complex manifold system. The system may also include a backwashing system to facilitate the cleaning of the filter media used.

### BACKGROUND OF THE INVENTION

Water filtration systems for residential pools are made up of several independent mechanical components arranged in an area set apart from the pool. The list of mechanical components includes pumps, filters, heaters, chemical dispensers and a complex plumbing manifold from one component to the next with an inlet from and a return to the pool. Both the installation and servicing of these components require specialized training making it difficult for the end consumer to maintain. In addition, these components are commonly left exposed and grouped together in a location. Often, fences or landscaping are used to shield these component from view with varying levels of success. The components are generally left uncovered resulting in unpleasant sounds when various portions of the equipment are operating.

### SUMMARY OF THE INVENTION

An integrated pool filtration system according to various aspects of the present technology is configured to provide a single fully contained unit incorporating a full suite of equipment for pool filtration to provide a simpler installation option. In one embodiment, the system comprises an inlet and an outlet that can be easily connected to the plumbing system of a pool and an electrical panel that can be connected to an appropriate power source eliminating the need for a complex manifold system. The system may also include a backwashing system to facilitate the cleaning of the filter media used.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates an exterior view of a self-contained filtration system in accordance with an exemplary embodiment of the present technology;

FIG. 2 representatively illustrates a view of the self-contained filtration system shown in FIG. 1 with an access lid opened in accordance with an exemplary embodiment of the present technology;

FIG. 3 representatively illustrates a view of the self-contained filtration system with the access lid removed to reveal internal components in accordance with an exemplary embodiment of the present technology;

FIG. 4 representatively illustrates an internal view of the self-contained filtration system showing internal chambers in accordance with an exemplary embodiment of the present technology;

FIG. 5 representatively illustrates a filtration system without a housing in accordance with an exemplary embodiment of the present technology;

FIG. 6 representatively illustrates a filtration flow path for the self-contained filtration system in accordance with an exemplary embodiment of the present technology;

FIG. 7 representatively illustrates a backwash flow path for the self-contained filtration system in accordance with an exemplary embodiment of the present technology;

FIG. 8 representatively illustrates an alternative embodiment of the self-contained filtration system in accordance with an exemplary embodiment of the present technology;

FIG. 9 representatively illustrates a view of the self-contained filtration system shown in FIG. 8 with the access lid removed to reveal internal components in accordance with an exemplary embodiment of the present technology;

FIG. 10 representatively illustrates another embodiment of the self-contained filtration system in accordance with an exemplary embodiment of the present technology; and

FIG. 11 representatively illustrates a view of the self-contained filtration system shown in FIG. 10 with the access lid removed to reveal internal components in accordance with an exemplary embodiment of the present technology.

Elements and steps in the figures are illustrated for simplicity and clarity and have not necessarily been rendered according to any particular sequence. For example, components that may be coupled together in the manner shown or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of sensors, fittings, valves, fluid conduits, and the like, which may carry out a variety of functions. In addition, the present technology may be practiced in conjunction with any number of processes such as water filtration, chemical treatment, and the system described is merely one exemplary application for the technology. Further, the present technology may employ any number of conventional techniques for filtering and recirculating a water supply for a swimming pool, pond, or water fountain.

Methods and apparatus for an integrated pool filtration system according to various aspects of the present technology may operate in conjunction with any suitable water filtering system or recirculation system. Various representative implementations of the present technology may be applied to any filtering system for chemically treating, filtering, or recirculating water in a body of water. For example, in one embodiment, the integrated pool filtration system may be coupled to the plumbing lines of a residential swimming pool.

The integrated pool filtration system may comprise any suitable self-contained system for receiving an incoming water supply from a body of water, treating it, and directing it back into body of water. For example, the integrated pool filtration system may be used in place of a traditional segregated electrical pump and filtering system.

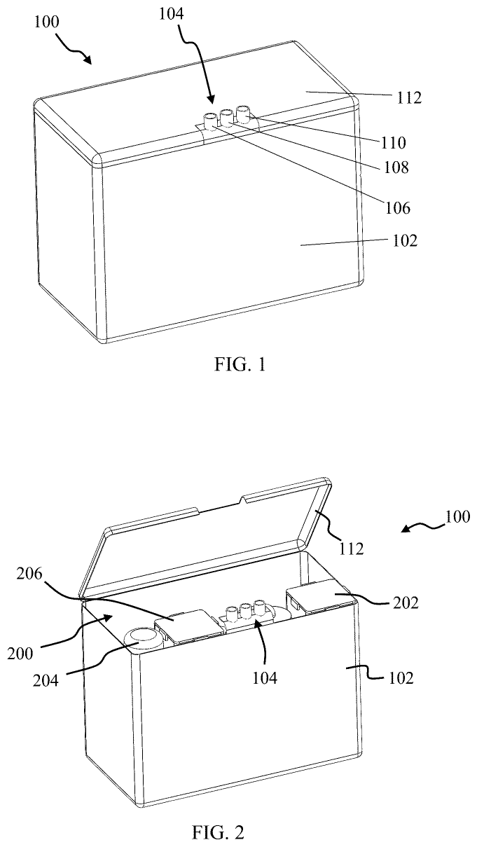

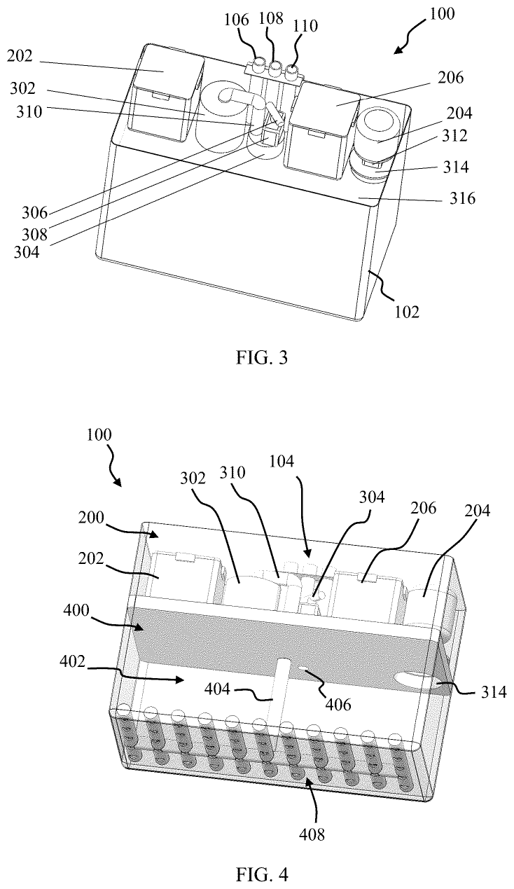

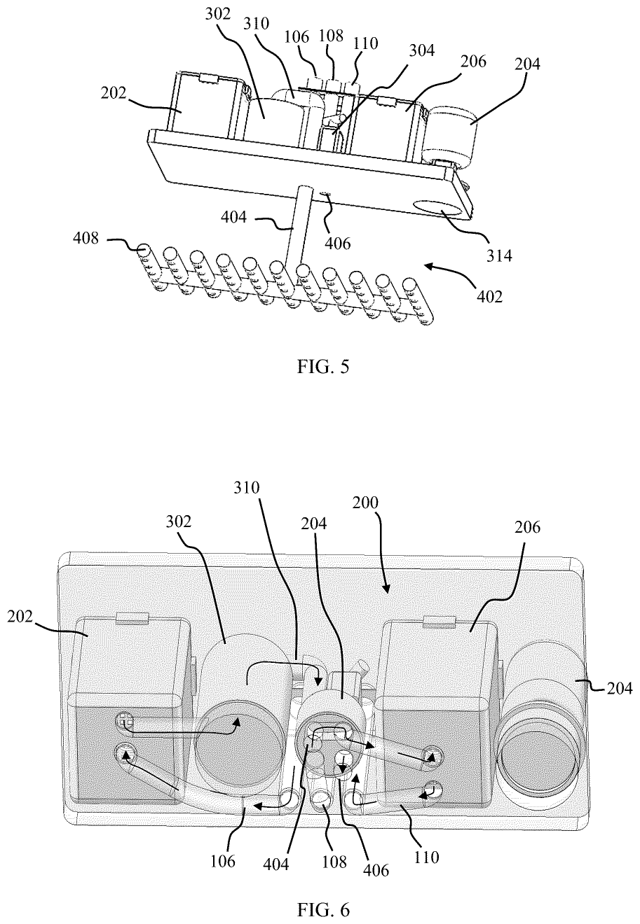

Referring now to FIG. 1, methods and apparatus for an integrated pool filtration system 100 may comprise a housing 102 having an interior volume for containing a filtration system and a lid 112 for enclosing or otherwise covering the filtration system from the ambient environment. A plumbing manifold 104 may extend through a portion of the housing 102 or lid 112 and comprise an inlet 106, a main outlet 110, and a drain line 108. Referring now to FIG. 2-5, The housing 102 may be configured to contain a pump 302, a filtration system 202, 206, 402, and plumbing ducts to facilitate the flow of water through the housing 102.

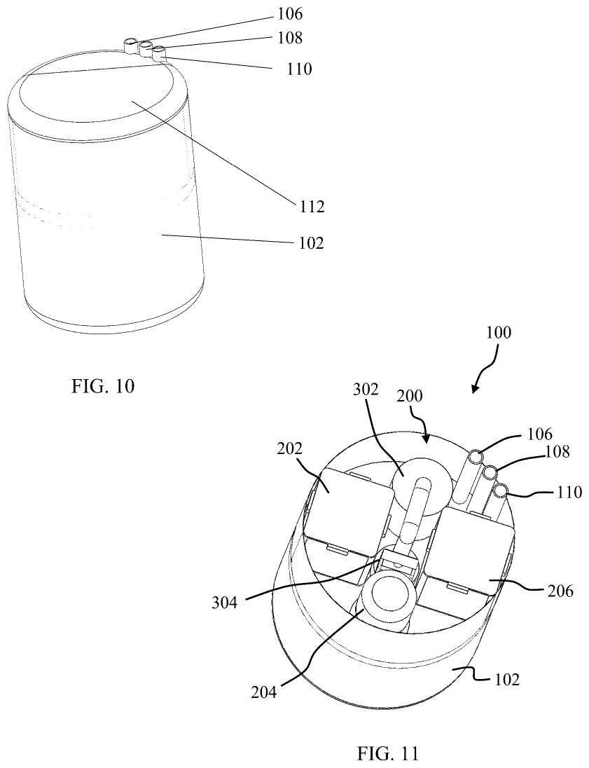

The housing 102 may comprise any suitable device for containing the components of the filtration system and may be formed of any suitable material such as metal, plastic, composite, or wood capable of being exposed to ambient conditions. The housing 102 may also comprise any suitable dimensions or shape configured to provide a desired arrangement of the components making up the filtration system. For example, in a first embodiment, the housing 102 may be configured in a generally rectangular shape. In a second embodiment, and referring now to FIGS. 8 and 9, the housing 102 may comprise a more vertically oriented cubic shape. As shown in FIGS. 10 and 11, in yet another embodiment, the housing 102 may comprise a more cylindrical shape. Other shapes may be used to more discretely blend into the environment where the housing 102 is configured to look like a boulder.

One or more sidewalls of the housing 102 or lid 112 may comprise materials for reducing the transmission of sound from inside of the housing 102. For example, the housing 102 may include sound deadening materials intended to reduce the transmission of sounds of the operating pump 302 from the inside of the housing 102 into the surrounding environment.

One or more exterior surfaces of the housing 102 may also be configured to improve the aesthetic appearance of the integrated pool filtration system 100. For example, in one embodiment, the exterior surfaces of the housing 102 may be configured to look like a large rock or boulder. In another embodiment, the exterior may be configured to blend into any surrounding structures such as a wall or side of a building.

In one embodiment, the housing 102 may comprise an upper chamber 200 and a lower chamber 400. The inlet 106 may provide a duct or flow path for an incoming water supply into the upper chamber 200. The upper chamber 200 may be configured to receive the incoming water supply through the pump 302 which generates a flow rate of water through the housing 102. A screening prefilter 202 may be positioned within or adjacent to the inlet 106 and upstream of the pump 302 to prevent larger debris (e.g., leaves, insects, or other landscaping materials) from entering or clogging the pump 302.

The upper chamber 200 may also house a post filter 206 configured to provide a final level of filtering/screening to the water and to direct the water flow towards the outlet 110 and back to the body of water. A main filter 402 may be located between the prefilter 202 and the post filter 206 and be disposed within the lower chamber 400 of the housing 102.

The pump 302 is configured to create a mass flow rate of water through the housing 102 from a water supply source connected to the inlet 106. The pump 302 may comprise any suitable system or device for creating a pressure differential of between about 10-20 pounds per square inch (psi) to the water supply to generate a flow of water through the housing 102. For example, the pump 302 may comprise an electrically powered water pump having any desired operating mechanics such as positive displacement, rotary, dynamic, centrifugal, axial, reciprocating, or the like that is capable of providing a mass flow of water of at least 10 psi to the filtration system. The pump 116 may also be configured to operate as either a single speed or variable speed pump and may be selected according to any suitable criteria.

The pump 302 may also be configured to operate within a confined area such as the interior of the housing 102. For example, the pump 302 may be configured to dissipate heat more efficiently as a result of being located in an area with reduced airflow. Alternatively, the housing 102 may comprise one or more vents (not shown) configured to allow air to flow through the upper chamber 106 of the housing 102 and help remove any heat generated by the pump 116 from the interior of the housing 102.

The filtration system is configured to clean the incoming water supply before it is returned to the body of water. The filtration system may comprise any suitable device or combination of devices for filtering selected particulates from the water flowing through the housing 102. The filtration system may also be configured to use one or more type of media to perform filtration. In one embodiment, the filtration system may comprise a series of filters configured to perform differing levels of filtration or clarification of the water flow.

In one embodiment, the prefilter 202 may be installed immediately upstream of the pump 302 and be configured to filter out larger particulate material such as in the range of about 60-100 microns to help extend the life of the main filter 402. The prefilter 202 may be comprised of any suitable filter media such as a cartridge style filter membrane. The prefilter 202 may be configured for single use and be replaceable after a predetermined period of time or use or be configured for continuous use after being cleaned or rinsed after a period of time.

The main filter 402 may be configured to provide filtration down to about 3-25 microns and may comprise any suitable filter media. For example, in one embodiment, the main filter 402 may comprise a bed of sand or diatomaceous earth (DE) distributed in the lower chamber 108. Alternatively, the main filter 402 may comprise one or more cartridge style filters providing a much greater surface area for filtration as compared to the prefilter 202.

In yet another embodiment, the lower chamber 400 may be divided into multiple sub-chambers forming the main filter 402, wherein each sub-chamber is configured to provide a different level or style of filtration. For example, each sub-chamber may use a different filtration media, to form a layered in-depth filtration bed. A valve may be used to open/close each sub-chamber to achieve more precise control of filtration through the main filter 402. The sub-chambers may be arranged in any suitable manner such as vertically or horizontally.

The post filter 206 may be configured to provide additional clarification or purification to the water flow before it exits the housing 102. The post filter 206 may comprise any system or device for providing additional treatment to the water. For example, in one embodiment, the post filter 206 may comprise a system for killing bacteria that may be present in the flow of water. In another embodiment, the post filter 206 may comprise a smaller volume of DE compared to a volume of sand making up the main filter 120 to provide enhanced filtration to the water flow.

In yet another embodiment, the post filter 206 may also be configured to chemically treat the water flow such as by adding chlorine or salt to the water flow. For example, a chemical dosing system 204 may be connected to the post filter 206 and configured to inject or otherwise release one or more chemicals (e.g., chlorine or salt) into the water flow prior to exiting through the outlet 110 and returning to the pool.

The integrated pool filtration system 100 may further comprise one or more valves configured to selectively redirect the water flow through the housing. In one embodiment a multiport valve 304 may be located between the pump 302 and the main filter 402. The multiport valve 304 may be used to selectively prevent the flow of water from flowing directly into the lower chamber 400 and contacting the main filter 402. For example, the multiport valve 304 may be responsive to a command from a control panel 316 and move between a first filtering position allowing the flow of water directly from the pump 302 to the main filter 402 and subsequently to the post filter 206 and a second backwash position that reverses the flow of water through the main filter 402 and out to a drain bypassing the post filter 206. The backwash position may be used to periodically flush or otherwise clean the main filter media within the main filter 402.

Referring now to FIG. 6, in filtering position, water may flow from the pump 302 into the multiport valve 304 through a supply duct 310. The multiport valve 304 may then direct the flow into the lower chamber 400 through a filter port 406 where the water flow passes downwardly through the filter media of the main filter 402. Filtered water may enter a series of tubes 408 located along a bottom surface of the lower chamber 400 and flow back upwardly to the multiport valve 304 through a return line 404. The water flow is then directed through the multiport valve 304 to the post filter 206 and then to the outlet 110 before returning to the pool itself.

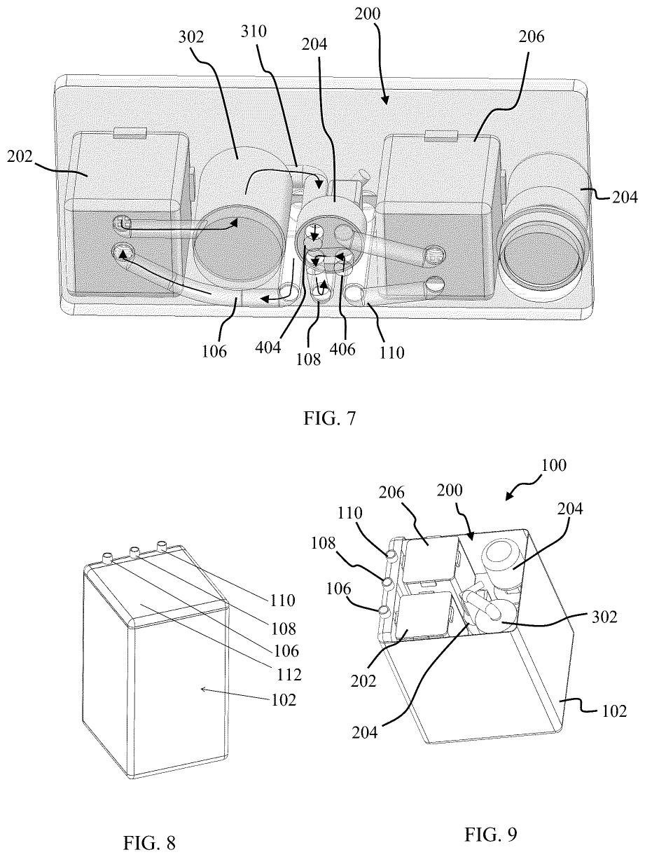

Referring now to FIG. 7, in backwash position, water may flow from the pump 302 into the multiport valve 304 through a supply duct 310. The multiport valve 304 may then direct the flow into the lower chamber 400 through the return line 404 and series of tubes 408 causing the water flow to move upwardly through the filter media of the main filter 402. Backwashed water then flows back into the multiport valve 304 through the filter port 406. The water flow is then directed through the multiport valve 304 to the drain line 108 without passing through the post filter 206.

The multiport valve 304 may comprise any suitable device or system for allowing or restricting the flow of water to a desired direction such as a gate valve, ball valve, bypass valve, and the like. The multiport valve 304 may also be configured to be responsive to commands from the control panel 316 to allow for automated operation. For example, a solenoid 308 may be used to receive an electrical signal from the control panel 316 causing the multiport valve 304 to actuate and redirect the flow of water when desired. The multiport valve 304 may also comprise a manual valve actuator 306 to allow for manual selection of the backwash position of the multiport valve 304.

The control panel 316 may be used to control operation of the pump 302 and the multiport valve 304 on a predetermined schedule or at a desired interval. For example, the control panel 316 may comprise a programmable circuit board having a user interface. The control panel 316 may be located within the upper chamber 200 of the housing 102 or it may be positioned on an outer facing surface the lid 112 to allow for a user to access it without having to remove the lid 112.

The control panel 316 may also comprise a power supply. The power supply may be configured to be connected to a main power source such as an AC outlet or directly connected to a main power source such as an electrical panel. The power supply may divide incoming power between the pump 302, multiport valve 304, and the circuit board.

The control panel 316 may also be configured to be controlled wirelessly or by remote control. For example, the control panel 316 may comprise an antenna for receiving wireless signals such as through a local wireless network to allow the control panel 316 to be access remotely from a separate computing device such as a smartphone, tablet computer, or desktop computer. The control panel 316 may also be configured to communicate with other devices or systems such as a power company to limit hours of operation to times when electricity is at a lower rate (off-peak).

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to a preferred embodiment. However, changes and modifications may be made to the preferred embodiment without departing from the scope of the present invention. These and other changes or modifications are intended to be included within the scope of the present technology, as expressed in the following claims.

1. A filtration system for a body of water, comprising:
a housing having an internal volume;
a lid configured to be selectively positioned on the housing to close off the internal volume;
a manifold for directing water through the housing, wherein the manifold comprises:
an inlet configured to receive water from the body of water;
and outlet configured to direct filtered water back to the body of water; and
a drain line;
a filter system located within the housing and positioned between the inlet and the outlet;
a pump located within the housing and positioned downstream from the inlet, wherein the pump is configured to:
receive the water; and
generate a flow of water through the housing and back to the body of water; and
a control panel connected to the pump and configured to control operation of the pump and the flow rate of the water generated by the pump.

2. A self-contained filtration system according to claim 1, wherein the filter system comprises:
a prefilter positioned between the inlet and the pump;
a main filter positioned downstream of the pump; and
a post filter positioned between the main filter and the outlet.

3. A self-contained filtration system according to claim 2, wherein the housing comprises:
an upper chamber containing the pump, the prefilter, and the post filter; and
a lower chamber containing the main filter.

4. A self-contained filtration system according to claim 3, further comprising a backwash system.

5. A self-contained filtration system according to claim 4, further comprising a multiport valve positioned between the pump and the main filter and configured to divert water flow between the main filter and the backwash system, wherein the multiport valve is connected to the control panel and responsive to an activation signal from the control panel causing the multiport valve to:
switch between a filter mode and a backwash mode; and
redirect the flow of water from the pump through the backwash system and to the drain line when the multiport valve is in backwash mode.

6. A self-contained filtration system according to claim 2, further comprising a chemical dosing system positioned downstream of the main filter.

7. A self-contained filtration system according to claim 6, wherein the chemical dosing system is configured to add chemicals to the water flow passing through the post filter.

8. A self-contained filtration system according to claim 1, further comprising a basket filter located between the inlet and the prefilter.

9. A self-contained filtration system according to claim 1, wherein the housing is configured to reduce transmission of sound through each housing sidewall.

10. A self-contained filtration system according to claim 1 wherein the main filter comprises a filter media.

11. A self-contained filtration system according to claim 1, wherein the control panel is located within the upper chamber of the housing.

12. A self-contained filtration system for receiving water from a body of water, comprising:
a housing having an internal volume, comprising:
an upper chamber; and
a lower chamber;
a removable lid configured to be selectively positioned over a top of the upper chamber of the housing to close off the internal volume;
an inlet passing through the housing to direct the water into upper chamber of the housing;
a pump located within upper chamber of the housing and positioned downstream from the inlet, wherein the pump is configured to:
receive the water from the inlet; and
generate a flow of water towards a housing outlet and back to the body of water;
a prefilter positioned between the inlet and the pump within the upper chamber of the housing;
a main filter positioned within the lower chamber of the housing and downstream of the pump;
a post filter positioned between the main filter and the outlet within the upper chamber of the housing; and
a control panel connected to the pump and configured to control a flow rate of the water through the pump.

13. A self-contained filtration system according to claim 12, further comprising a backwash system.

14. A self-contained filtration system according to claim 13, further comprising a multiport valve positioned between the pump and the main filter and configured to divert water flow between the main filter and the backwash system, wherein the multiport valve is connected to the control panel and responsive to an activation signal from the control panel causing the multiport valve to:
switch between a filter mode and a backwash mode; and
redirect the flow of water from the pump through the backwash system and to a drain line when the multiport valve is in backwash mode.

15. A self-contained filtration system according to claim 12, further comprising a basket filter located between the inlet and the prefilter.

16. A self-contained filtration system according to claim 12, wherein the housing is configured to reduce transmission of sound through each housing sidewall.

17. A self-contained filtration system according to claim 12 wherein the main filter comprises a filter media.

18. A self-contained filtration system according to claim 12 wherein the control panel is located within the upper chamber of the housing.

19. A self-contained filtration system according to claim 12, further comprising a chemical dosing system positioned downstream of the main filter.

20. A self-contained filtration system according to claim 19, wherein the chemical dosing system is configured to add chemicals to the water flow passing through the post filter.
